(19) United States
(12) Patent Application Publication
(10) Pub. No.: US 2002/0135435 A1
(43) Pub. Date: Sep. 26, 2002

(54) Waveguide with coplanar printed probes

(76) Inventor: Chen Jun Jie, Chung-Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/811,595

(22) Filed: Mar. 20, 2001

(51) Int. Cl. H01P 1/161

(52) U.S. Cl. 333/21 A; 333/135; 333/26

(57) ABSTRACT

A waveguide is provided with coplanar printed probes that enable the waveguide to have reduced volume and enhanced signal processing ability. The waveguide includes a cup-shaped tube portion, a body portion behind the tube portion, and a circuit board for receiving and processing wave signals. The circuit board is provided at one side facing away from the tube portion with two printed probes that are perpendicular to and spaced from each other by a predetermined distance. And, the tube portion is provided at a position facing one of the two printed probes that is located farther from the tube portion with a guide slot, so that wave could be guided into the guide slot and received by the printed probe facing the guide slot.

### BACKGROUND OF THE INVENTION

The present invention relates to a waveguide with printed probes, and more particularly to a waveguide having coplanar printed probes that are spaced from each other and have enhanced signal handling ability.

FIG. 1 shows a conventional waveguide 10 that includes a cup-shaped tube portion 11, a body portion 12, a circuit board 13, and two probe pins 14, 15. The probe pins 14, 15 are spaced from and perpendicular to each other, so as to receive waves of different directions and then transmit the received waves as signals to the circuit board 13, at where the received signals are processed.

The probe pins 14, 15 for the conventional waveguide 10 have the following disadvantages:

1. The probe pins 14, 15 are three-dimensional members projected from inner surfaces of the waveguide 10, and are therefore easily broken due to unexpected collision or impact.

2. The probe pins 14, 15 are three-dimensional members projected from inner surfaces of the waveguide 10, and therefore occupy considerable space in the waveguide 10, preventing the waveguide 10 from a small volume.

3. The cup-shaped tube portion 11 must have extended length to accommodate the long probe pins 14, 15.

It is therefore tried by the inventor to develop a waveguide having coplanar printed probes to eliminate the above-mentioned disadvantages.

### SUMMARY OF THE INVENTION

A primary object of the present invention is to provide a waveguide having coplanar printed probes, so that the waveguide could have reduced volume and enhanced signal processing ability.

To achieve the above and other objects, the waveguide of the present invention mainly includes a cup-shaped tube portion, a body portion behind the tube portion, and a circuit board for receiving and processing received wave signals. The circuit board is provided at one side facing away from the tube portion with two printed probes that are perpendicular to and spaced from each other by a predetermined distance. And, the tube portion is provided at a position facing one of the two printed probes that is located farther from the tube portion with a guide slot, so that wave could be guided into the guide slot and received by the printed probe facing the guide slot.

Since the printed probes of the waveguide are provided on the same plane, the volume of the waveguide is minimized and the probability of damaged printed probes due to collision or impact is almost zero, allowing the waveguide to be more durable and have prolonged usable life. The printed probes are sufficiently spaced from each other in the waveguide to avoid the problem of wave interference, enabling the waveguide to have enhanced function. The provision of the guide slot enables the farther probe to effectively receive the wave in the direction of the guide slot and therefore enhances the waveguide, too.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective of a conventional waveguide;

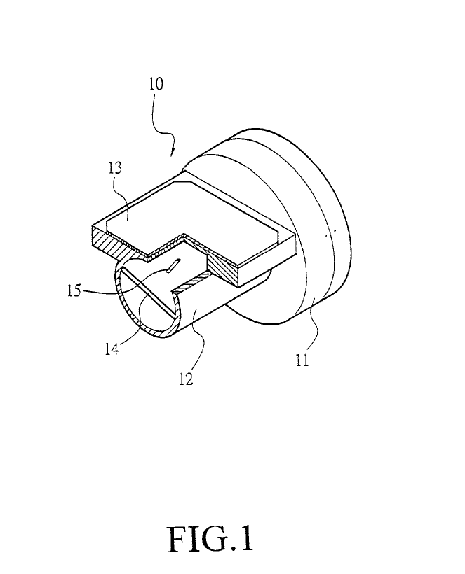

FIG. 2 is an exploded perspective of a waveguide according to a preferred embodiment of the present invention;

FIG. 3 is an enlarged view of a circuit board for the waveguide of FIG. 2; and

FIG. 4 is a fragmentary cross sectional view of the waveguide of FIG. 2 near a cup-shaped tube portion thereof.

### DETAILED DESCRIPTION OF THE PREFERRED EMBODIMENTS

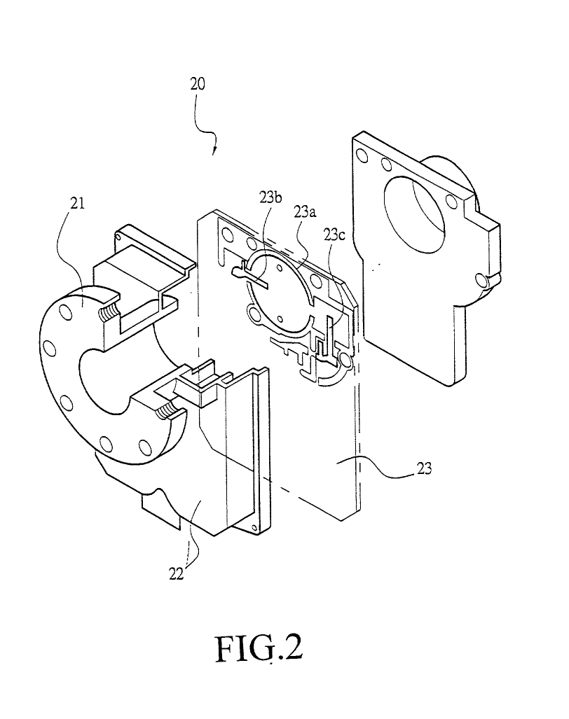

Please refer to FIG. 2 that is an exploded perspective of a waveguide 20 according to a preferred embodiment of the present invention. The waveguide 20 includes a cup-shaped tube portion 21, a body portion 22 vertically connected to a rear side of the cup-shaped tube portion 21, and a circuit board 23 mounted on the body portion 22 and perpendicular to the tube portion 21.

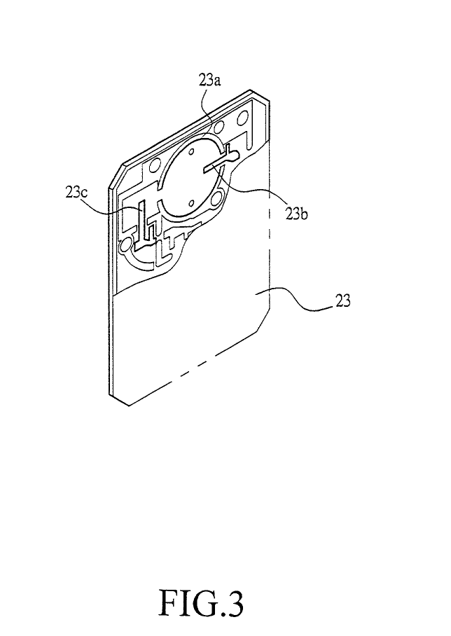

The circuit board 23 is provided thereon with a pattern 23a of a printed circuit, as shown in FIG. 3. In the pattern 23a, there are printed probes 23b, 23c perpendicular to and spaced from each other by a predetermined distance, so that the printed probes 23b, 23c are able to receive waves in two perpendicular directions without causing wave interference. The probe 23c is located farther away from the tube portion 21 as compared with the other probe 23b.

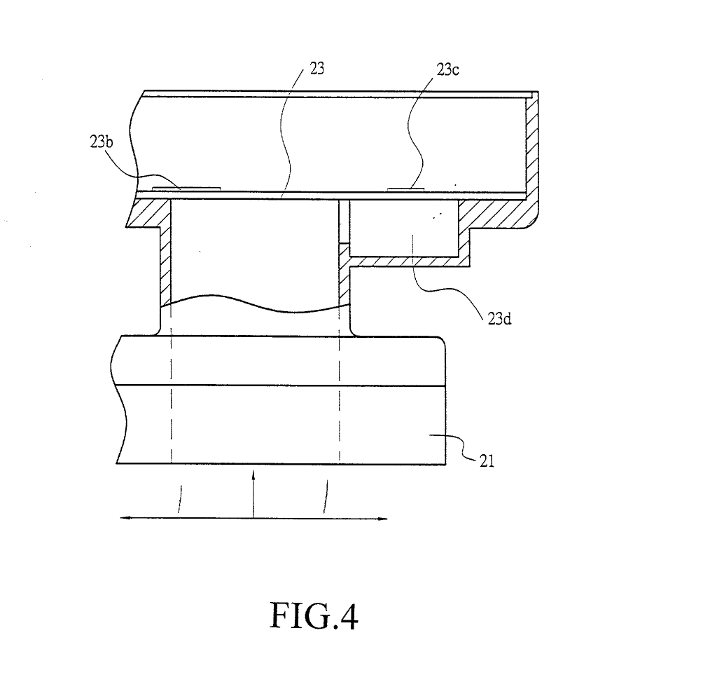

Please refer to FIG. 4. The cup-shaped tube portion 21 is provided at a position adjacent to the printed probe 23c with a guide slot 23d, so that wave in the direction of the guide slot 23d of the cup-shaped tube portion 21 can be effectively received by the probe 23c and converted into an electronic signal. Due to the printed patterned probes and the provision of the guide slot 23d, the coplanar probes 23b and 23c are spaced from each other by a predetermined distance to effectively process waves without causing wave interference.

It is to be noted that the two perpendicular and spaced printed probes 23b and 23c are formed at one side of the circuit board 23 facing away from the cup-shaped tube portion 21. Moreover, the cup-shaped tube portion 21 includes a guide slot 23d facing one of the two printed probes that is located farther from the cup-shaped tube portion 21 (that is, the printed probe 23c in the illustrated embodiment), so that wave could be guided thereinto and effectively received by the probe 23c. With these arrangements, probes for the waveguide 20 could be provided on the same plane to reduce space needed by the waveguide 20 for the same to have a minimized volume. Since the probes 23b and 23c printed on the same plane are not subjected to damage due to collision or impact, the probability of damaged probes due to collision or impact is almost zero. Thus, the waveguide 20 with coplanar printed probes is more durable and has prolonged usable life. The waveguide having the above-described structure has probes sufficiently spaced from each other and can therefore avoid the problem of wave interference to provide enhanced function thereof.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A waveguide with coplanar printed probes, comprising a cup-shaped tube portion, a body portion vertically connected to a rear side of the cup-shaped tube portion, and a circuit board mounted on the body portion and perpendicular to the tube portion for receiving and processing wave signals; said waveguide being characterized in that said circuit board is provided at one side facing away from said tube portion with two printed probes that are perpendicular to and spaced from each other by a predetermined distance, and that said tube portion is provided at a position facing one of said two printed probes that is located farther from said tube portion with a guide slot, so that wave could be guided into said guide slot and received by said printed probe facing said guide slot.
